(19) United States
(12) Patent Application Publication
(10) Pub. No.: US 2017/0270129 A1
(43) Pub. Date: Sep. 21, 2017

(54) APPLICATION SERVER, CLOUD DEVICE, STORAGE MEDIUM ACCESS MONITORING METHOD, AND COMPUTER-READABLE STORAGE MEDIUM HAVING COMPUTER PROGRAM STORED THEREON

(71) Applicant: NEC Corporation, Minato-ku, Tokyo (JP)

(72) Inventor: Masayoshi OHUCHI, Tokyo (JP)

(73) Assignee: NEC Corporation, Minato-ku, Tokyo (JP)

(21) Appl. No.: 15/512,181

(22) PCT Filed: Sep. 15, 2015
(86) PCT No.: PCT/JP2015/004688

§ 371 Date: Mar. 17, 2017

(30) Foreign Application Priority Data
Sep. 24, 2014 (JP) 2014-193422

(51) Int. Cl. G06F 17/30

(52) U.S. Cl. CPC G06F 17/30085; G06F 17/30215; H04L 67/1097

(57) ABSTRACT

Provided are an application server, etc. which can solve the problem of delay in access to a storage medium experienced by an application program running on the application server. This application server is equipped with: an execution unit which executes an application program in response to a request from a client device, and returns a response to the client device; a measurement unit which measures a value representing an access performance for a storage medium exhibited when the application program is executed; and a management unit which performs control to add another storage medium if the management unit determines, based on the value measured by the measurement unit, that the access performance for the storage medium is degraded.

### TECHNICAL FIELD

The present invention relates to an application server and the like which execute an application for access to a storage medium.

### BACKGROUND ART

In a cloud environment, provided is an application running on an application server constructed on a cloud node. The application performs processing by reading data from a storage medium. Alternatively, the application performs processing by obtaining input data from a terminal or the like via a network. Then, the application writes a result of the processing in the storage medium and returns the result as a response to the terminal or the like. A cloud system including a server executing such an application is required to instantaneously return a processing result to a terminal. Alternatively, the cloud system is required to be punctual in a scheduled completion time for each of successive processes. Thus, the cloud system is desired to prevent processing delay due to an external factor as much as possible.

The external factor, causing the delay in application processing, includes time such as time taken for network communication, time for processing of a database server or processing of another server, and time taken for access to a file. The delay in the network communication has been reduced to an almost ignorable degree owing to remarkable increase in speed in a recent communication technology. However, in order to reduce waiting time for processing of the database server and the other server, there is no way but to solve a cause of performance degradation in the servers, and hence a versatile countermeasure cannot be taken.

As for the file, a high-speed Solid State Drive (SSD) has been emerging in recent years. However, since the SSD has an issue in terms of cost and durability, a magnetic disk is mainly used even now for a file. In a magnetic disk with random access, disk rotation speed is determined for each device. Therefore, when a load to same magnetic disk increases due to concentration of accesses to the same disk, the same disk cannot instantaneously deal with each of the accesses, which results in remarkable decrease in read or write performance. Thus, a system with a large number of accesses to a magnetic disk has been required to change timing for access to a file while measuring an access load to the disk in order to efficiently perform a plurality of processes. Alternatively, such a system has been required to separately use disks for each of the processes to access.

Examples of related arts existing prior to filing of the present application include PTLs below.

In a system described in PTL 1, a gateway is provided between a server and a host, and the gateway measures service time of the server. The system determines, based on the service time, a busy state of the server.

PTL 2 discloses a multistage online transaction system with a reduced number of times of access to a Network Attached Storage (NAS) by use of a shared memory.

PTL 3 discloses a system configuration management device capable of determining whether a server is to be added or a storage is to be added based on an incremental capacity of a storage device in use.

PTL 4 discloses a data storage method aiming for load distribution by subdividing data to be stored in a disk device, arranging the subdivided data in a plurality of disks, and storing copies of the data in another disk device.

### CITATION LIST

### Patent Literature

[PTL 1] Japanese Translation of PCT International Application Publication No. 2014-505918
[PTL 2] Japanese Unexamined Patent Application Publication No. 2010-262355
[PTL 3] Japanese Unexamined Patent Application Publication No. 2006-011860
[PTL 4] Japanese Unexamined Patent Application Publication No. 2000-322292

### SUMMARY OF INVENTION

### Technical Problem

The technique proposed in PTL 1 aims to avoid overloading of a server by stopping requesting the server for a certain period of time, when determining that the server is in a busy state. However, occurrence of processing delay when the server accesses to a file is left out of consideration.

The technique proposed in PTL 2 aims to improve processing speed by reducing the number of times of accesses to a NAS. However, occurrence of processing delay when accessing to a file is left out of consideration in PTL 2.

PTL 3 focuses on only an incremental capacity of a storage device, but leaves processing delay in the storage device out of consideration.

PTL 4 is a technique for an arrangement when storing data, but leaves a countermeasure against occurrence of processing delay out of consideration.

In other words, the techniques proposed in PTLs 1 to 4 leave a countermeasure against occurrence of delay in access to a file in an application program out of consideration.

In view of the above, a main object of the present invention is to provide an application server and the like capable of eliminating delay in access to a storage medium when the delay occurs during execution of an application program running on the application server.

### Solution to Problem

The application server to affect one state of the present invention includes the following constitution in order to achieve the purpose mentioned above.

In other words, an application server to affect one state of the present invention comprises execution means which executes an application program in response to a request from a client device and returns a response to the client device; measurement means which measures a value representing performance in access to a storage medium through execution of the application program; and management means which, when determining that the performance relating to the access to the storage medium is degraded based on the value measured by the measurement means, performs control so as to add another storage medium.

A storage medium access monitoring method to affect one state of the present invention, to achieve the purpose comprises executing an application program in response to a request from a client device; measuring a value representing performance in access to a storage medium through execution of the application program; and performing, when determining that the performance relating to the access to the storage medium is degraded based on the measured value, control so as to add another storage medium.

Further the purpose is achieved by a computer program and a computer-readable storage medium storing the computer program which causes a computer to execute an application server which be comprised above and a storage medium access monitoring method.

### Advantageous Effects of Invention

The present invention described above has an advantageous effect of being capable of eliminating delay in access to a storage medium when the delay occurs in an application program running on an application server.

### BRIEF DESCRIPTION OF DRAWINGS

FIG. 1 is a block diagram illustrating a configuration of a system according to a first example embodiment of the present invention;

FIG. 2 is a block diagram illustrating a configuration of an information processing system according to a second example embodiment of the present invention;

FIG. 3A is a diagram exemplifying a path conversion table according to the second example embodiment of the present invention;

FIG. 3B is a diagram exemplifying an access record table according to the second example embodiment of the present invention;

FIG. 4 is a flowchart illustrating processing of an application in a server application execution unit according to the second example embodiment of the present invention;

FIG. 5 is a flowchart illustrating a file access process according to the second example embodiment of the present invention;

FIG. 6 is a flowchart illustrating a process for adding a file according to the second example embodiment of the present invention;

FIG. 7 is a flowchart illustrating a process for deleting a file according to the second example embodiment of the present invention;

FIG. 8A is a diagram exemplifying a path conversion table obtained after a first file access according to the second example embodiment of the present invention;

FIG. 8B is a diagram exemplifying an access record table obtained after a first file access according to the second example embodiment of the present invention;

FIG. 9A is a diagram exemplifying a path conversion table obtained after detection of prolonged file access time according to the second example embodiment of the present invention;

FIG. 9B is a diagram exemplifying an access record table obtained after detection of prolonged file access time according to the second example embodiment of the present invention;

FIG. 10A is a diagram exemplifying a path conversion table obtained after detection of shortened file access time according to the second example embodiment of the present invention;

FIG. 10B is a diagram exemplifying an access record table obtained after detection of shortened file access time according to the second example embodiment of the present invention;

FIG. 11A is a diagram exemplifying a path conversion table obtained when file access time is neither prolonged nor shortened according to the second example embodiment of the present invention;

FIG. 11B is a diagram exemplifying an access record table obtained when file access time is neither prolonged nor shortened according to the second example embodiment of the present invention;

FIG. 12 is a diagram exemplifying an access record table according to a third example embodiment of the present invention;

FIG. 13 is a block diagram illustrating a configuration of a system according to a fourth example embodiment of the present invention;

FIG. 14 is a diagram exemplifying an access record table according to the fourth example embodiment of the present invention; and

FIG. 15 is a diagram illustratively describing a hardware configuration of a computer (information processing device) capable of implementing the first to fourth example embodiments of the present invention.

### DESCRIPTION OF EMBODIMENTS

Next, modes for carrying out the present invention will be described in detail with reference to the drawings.

### First Example Embodiment

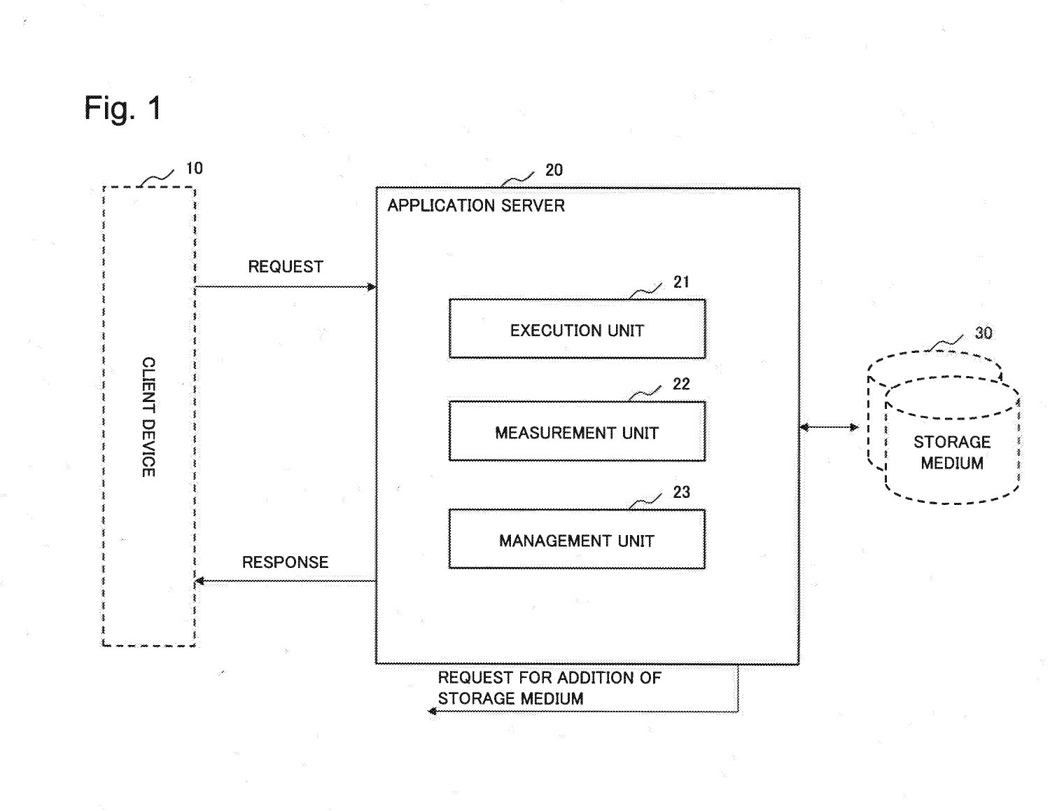

FIG. 1 is a block diagram illustrating a configuration of a system according to a first example embodiment of the present invention. In each of the example embodiments below, a direction of an arrow in the drawings indicates an example and is not intended to limit a direction of a signal between blocks.

The system according to the present example embodiment includes a client device 10, an application server 20, and a storage medium 30.

The client device 10 transmits a request to the application server 20 and receives a response from the application server 20.

The storage medium 30 stores data (a file, a database, or the like) to which an application program or the like executed in the application server 20 accesses.

The application server 20 includes an execution unit 21, a measurement unit 22, and a management unit 23.

The execution unit 21 executes an application in response to a request from the client device 10 and controls execution of an application program for returning a response to the client device 10.

The measurement unit 22 controls access to the storage medium 30 through execution of an application program and measures a value representing performance in access to the storage medium 30 (hereinafter, also referred to as a performance value).

The management unit 23, when determining that the performance relating to the access to the storage medium 30 is degraded based on the performance value measured by the measurement unit 22, performs control so as to add a recording medium to the storage medium 30.

As described above, an advantageous effect of the first example embodiment is being capable of eliminating delay detected in access to the storage medium 30 through execution of an application program running on the application server 20.

The reason is that the application server 20 according to the present example embodiment measures a value representing performance in access to the storage medium 30 and determines, based on the value, whether the performance relating to the access is degraded. The application server 20, when determining that the performance is degraded, adds a storage medium. Accordingly, the application server 20 prevents delay caused by access concentration to a particular storage medium.

### Second Example Embodiment

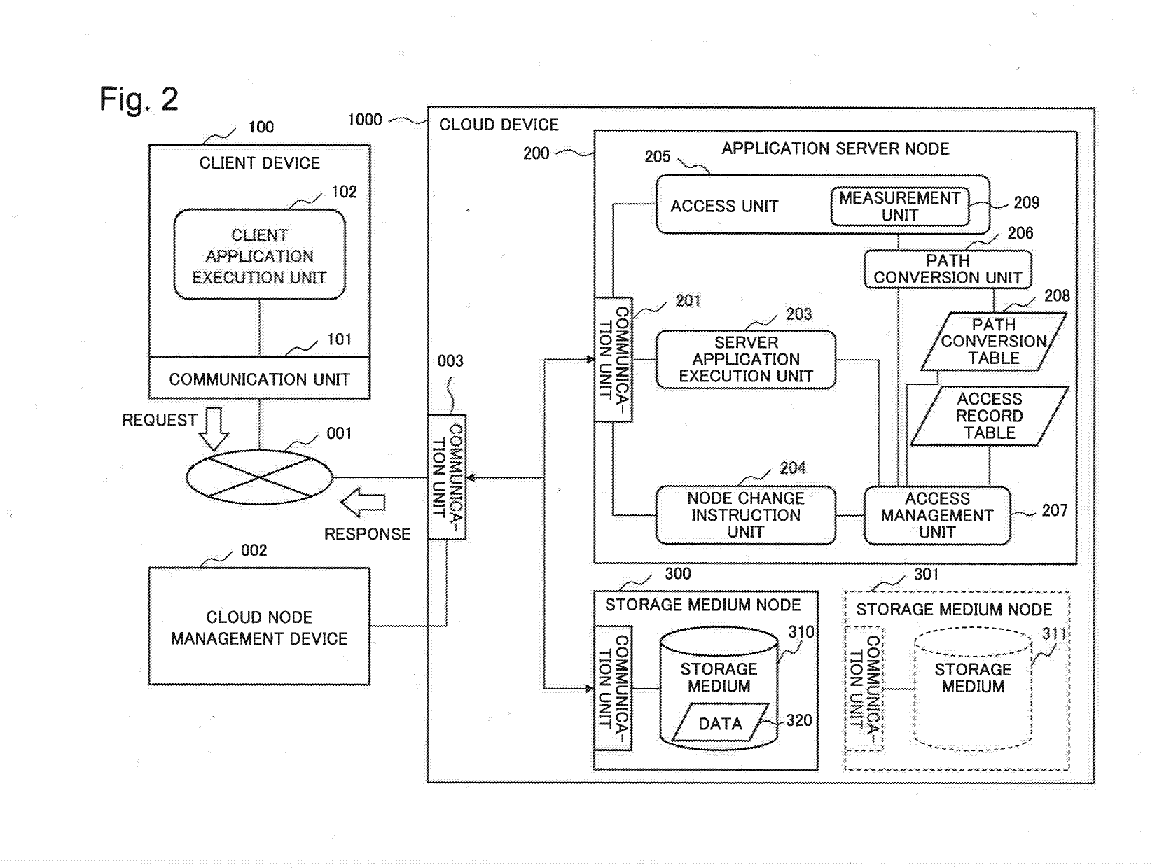

Next, a second example embodiment using the application server according to the above-described first example embodiment as a basis will be described. FIG. 2 is a block diagram illustrating a configuration of an information processing system according to the second example embodiment of the present invention. However, the configuration illustrated in FIG. 2 is an example, and the present invention is not limited to the information processing system illustrated in FIG. 2.

The information processing system according to the present example embodiment includes a client device 100, a cloud device 1000, and a cloud node management device 002.

The client device 100 includes a communication unit 101 and a client application execution unit 102.

The communication unit 101 communicates with the cloud device 1000 via a network 001. The client application execution unit 102 controls execution of an application in the client device 100.

The cloud node management device 002 controls addition and deletion of nodes included in the cloud device 1000. A cloud device controlled by the cloud node management device 002 is not limited to the cloud device 1000 illustrated in FIG. 2, but another cloud device can also be controlled.

The cloud device 1000 includes a communication unit 003, an application server node 200, and storage medium nodes 300 and 301. Nodes used in the cloud device 1000 are not limited to the application server node 200 and the storage medium node 300 illustrated in FIG. 2, but another node may be included.

The communication unit 003 communicates with an external device (such as the client device 100) of the cloud device 1000 via the network 001. The external device herein includes the client device 100 and the cloud node management device 002.

The storage medium node 300 includes a communication unit and a storage medium 310 which stores data 320.

The application server node 200 includes a communication unit 201, a server application execution unit 203, a node change instruction unit 204, an access unit 205, a path conversion unit 206, an access management unit 207, a path conversion table 208, and an access record table 210. Note that the path conversion table 208 and the access record table 210 correspond to a not-illustrated recording device connected with the access management unit 207 and the path conversion unit 206. In addition, the access unit 205 includes a measurement unit 209. The server application execution unit 203, the access unit 205, the path conversion unit 206, the path conversion table 208, and the access record table 210 are an example of the execution unit 21 in the first example embodiment. Similarly, the node change instruction unit 204 and the access management unit 207 are an example of the management unit 23 in the first example embodiment.

The communication unit 201 is connected with the communication unit 003. In addition, the communication unit 201 is housed in the application server node 200 and communicates with the storage medium node 300 and another not-illustrated node. In FIG. 2, a communication path between the communication unit 201 and the other node is omitted.

The server application execution unit 203 is connected with the communication unit 201 and controls execution of an application in an application server. Note that the server application execution unit 203 may cooperate with the access unit 205 to be described later.

The node change instruction unit 204 requests, via the communication unit 201, the cloud node management device 002 to add and delete a storage medium node.

The access unit 205 controls access to a storage medium node (for example, a file). Further, the access unit 205 instructs the measurement unit 209 to perform measurement of time required for access. The measurement unit 209 measures time based on the instruction.

According to the example embodiment of the present invention, when the access management unit 207 detects delay in file access, a storage medium node is added as will be described later. The path conversion table 208 stores information on a file path used when a file of an added storage medium node is used (for example, information on a file access destination). Meanwhile, the access record table 210 stores a history of time measured by the measurement unit 209 together with information on a file path used in file access for each measured time.

The path conversion unit 206 obtains a file path used in actual access to a file, based on a content of the path conversion table 208.

The access management unit 207 stores, in the path conversion table 208 and the access record table 210, information on time measured by the measurement unit 209 and information on a file path described above each transferred from the path conversion unit 206. In addition, the access management unit 207 determines whether access delay due to lowered file access performance is occurring, based on time measured by the measurement unit 209 upon file access and a content of the access record table 210. When determining that access delay is occurring, the access management unit 207 issues an instruction for the node change instruction unit 204 to add a storage medium node. On the other hand, when determining that there is a margin of performance, the access management unit 207 issues an instruction for the node change instruction unit 204 to delete an added storage medium node.

Next, an operation for a request and a response between the client device 100 and the cloud device 1000 will be described. The client device 100 transmits a request to the application server node 200 of the cloud device 1000 via the communication unit 101.

The request to the application server node 200 arrives at the server application execution unit 203 via the communication unit 201. Upon the arrival of the request, the server application execution unit 203 starts execution of a server application.

When the server application includes a process for ordering to access a file, the server application execution unit 203 instructs the access management unit 207 to read a file (data 320). Accordingly, the access management unit 207 instructs the path conversion unit 206 to read the file (data 320). The path conversion unit 206 obtains a file path for use in reading the file. The path conversion unit 206 then instructs the access unit 205 to read the file by using the file path. The access unit 205 reads, based on the instruction, the file (data 320) from the storage medium node 300. The data 320 read by the access unit 205 is transferred to the server application execution unit 203 via the path conversion unit 206 and the access management unit 207.

The server application execution unit 203 proceeds with processing of the application by using the read data 320 and creates a response including a processing result. The server application execution unit 203 then returns the created response to the client device 100 via the communication unit 201.

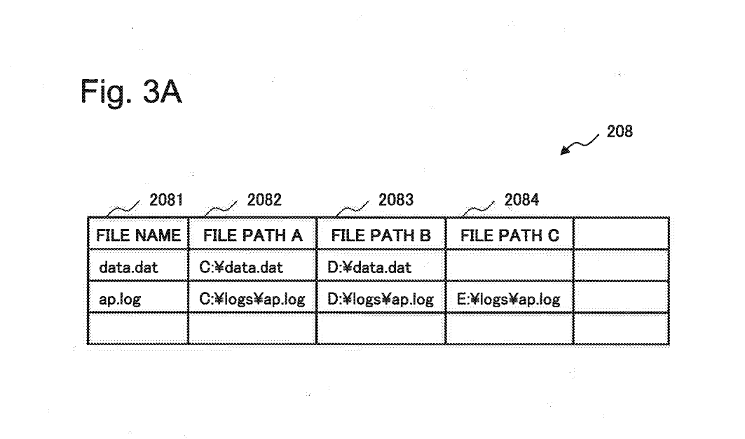

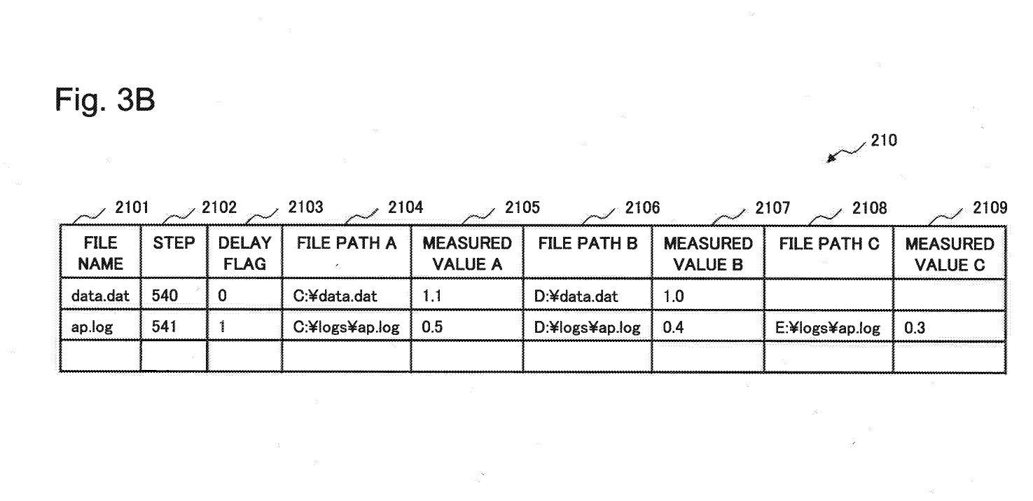

FIG. 3A is a diagram exemplifying a path conversion table according to the second example embodiment of the present invention. FIG. 3B is a diagram exemplifying an access record table according to the second example embodiment of the present invention. The path conversion table 208 illustrated in FIG. 3A and the access record table 210 illustrated in FIG. 3B are created by the access management unit 207.

The path conversion table 208 in FIG. 3A includes a file name 2081, a file path A (2082), a file path B (2083), and a file path C (2084).

The file name 2081 is a file name of a file to which an application executed by the server application execution unit 203 accesses.

The file path A (2082) is a file path for use in access to a file of the file name 2081 when a storage medium storing the file has not been changed (added).

The file path B (2083) is a file path for use in access to a file at a destination for change when a storage medium has been changed from the file to access using the file path A (2082).

The file path C (2084) is a file path for use in access to a file at a destination for change when a storage medium has been changed from the file to access using the file path B (2083).

The access record table 210 in FIG. 3B includes a file name 2101, a step 2102, a delay flag 2103, a file path A (2104), a measured value A (2105), a file path B (2106), a measured value B (2107), a file path C (2108), and a measured value C (2109).

The file name 2101 is a file name of a file to which an application accesses.

The step 2102 is an identifier indicating an application to access a file.

The delay flag 2103 is a flag indicating occurrence of delay in access to a file.

The file path A (2104) is a file path for use in access to a file of the file name 2101 when a storage medium storing the file has not been changed.

The measured value A (2105) is a period of time measured when accessing a file by using the file path A (2104).

The file path B (2106) is a file path for use in access to a file at a destination for change when a storage medium has been changed from the file to access using the file path A (2104).

The measured value B (2107) is a period of time measured when accessing a file by using the file path B (2106).

The file path C (2108) is a file path for use in access to a file at a destination for change when a storage medium has been changed from the file to access using the file path B (2106).

The measured value C (2109) is a period of time measured when accessing a file by using the file path C (2108).

### [Operation of Request and Response]

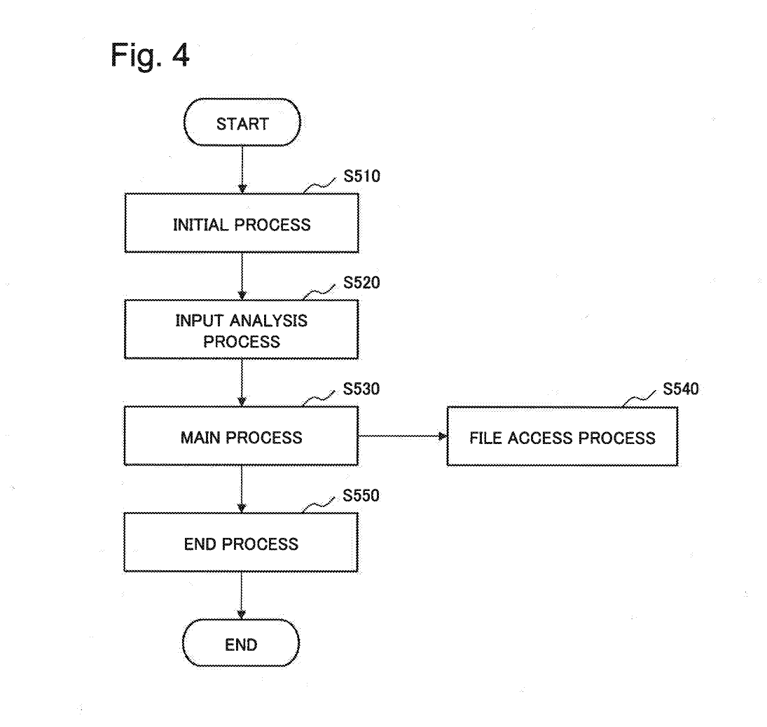

FIG. 4 is a flowchart illustrating processing of an application in the server application execution unit 203 according to the second example embodiment of the present invention. Firstly the application performs an initial process (Step S510). The initial process is, for example, a preprocess necessary for an application to run, such as initialization of a working area.

Next, the application performs an input analysis process (Step S520). The input analysis process is, for example, a process for analyzing a content of a request transmitted from the client device 100.

Then, the application performs a main process (Step S530). The main process is a process for accomplishing a content expected to be carried out by an application. When the main process needs to access a file, the application instructs the access unit 205 from the access management unit 207 via the path conversion unit 206 to perform a file access process (Step S540).

Finally, the application performs an end process (Step S550). The end process performs, for example, creation of a response to return to a client and transmission thereof.

### [File Access Process]

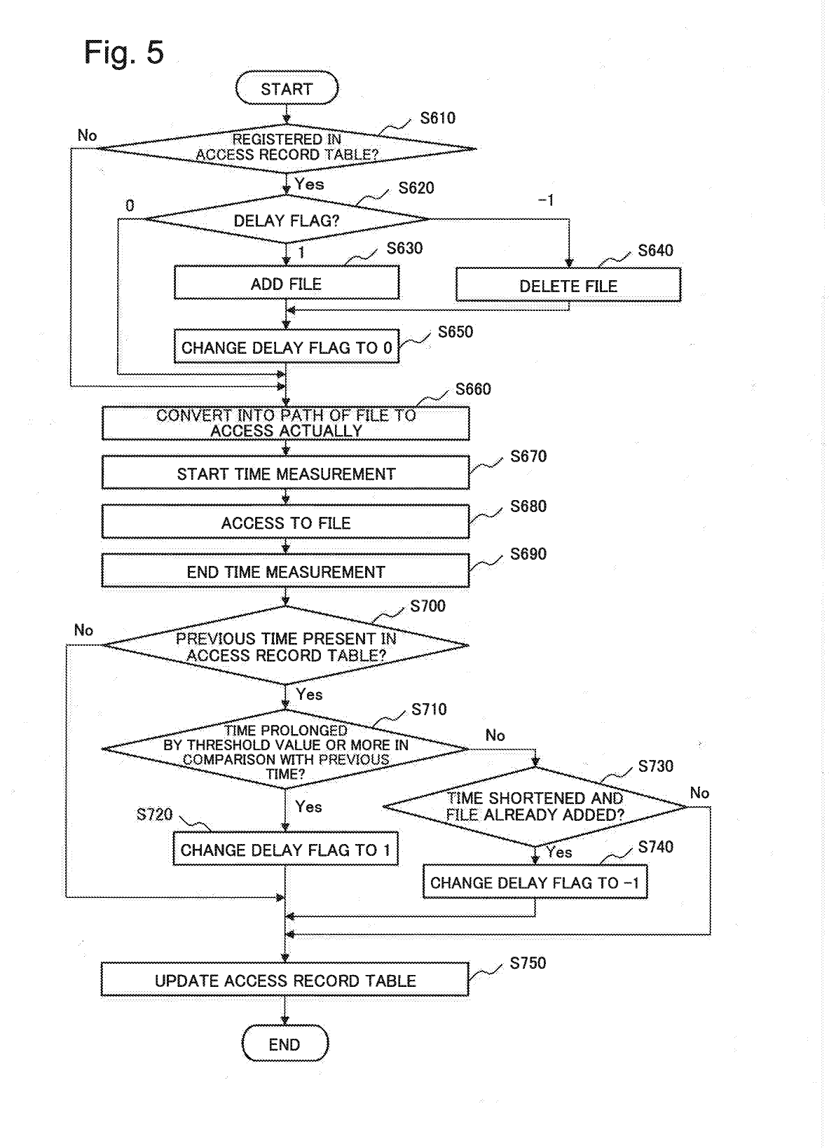

In the following, the file access process S540 indicative of a characteristic of the present invention will be described with reference to flowcharts (FIGS. 5 to 7). FIG. 5 is a flowchart illustrating a file access process according to the second example embodiment of the present invention.

Description is given using an example of a file access process for reading the data 320 stored in the storage medium 310 included in the storage medium node 300. It is assumed that a file name and a file path of the data 320 are “data.dat” (hereinafter, referred to as a “file name aa”) and “C:¥Data.dat” (hereinafter, referred to as a “file path ax”), respectively. Hereinafter, the data 320 is also referred to as a file ad.

The access management unit 207 checks, due to an instruction from an application, whether an access target file is registered in the access record table 210 based on the file name aa (Step S610). In the first access to a certain file, no information relating to the file is registered in the path conversion table 208 and the access record table 210. Thus, Step S610 herein is “No”.

Next, the path conversion unit 206 references the path conversion table 208, and transfers a content of the file path ax as it is to the access unit 205 since a destination path converted from the file path ax is not registered.

The access unit 205 instructs the measurement unit 209 to start time measurement (Step S670). Then the access unit 205 accesses to the storage medium 310 included in the storage medium node 300 by using the file path ax and reads the data 320 (Step S680). Thereafter, the access unit 205 instructs the measurement unit 209 to end time measurement (Step S690). The measurement unit 209 measures time elapsed from the start of time measurement, that is, time required for reading the data 320.

The access unit 205 transfers the read data 320 and the measured time to the path conversion unit 206. The path conversion unit 206 transfers information transferred from the access unit 205 and information representing a file path (file path ax) to the access management unit 207.

The access management unit 207 confirms, by referencing the access record table 210, that no information on previous access to the file path ax is stored (“No” at Step S700).

The access management unit 207 records the measured time, the file path ax, and step information of the application in the access record table 210 in association with one another (Step S750). In other words, the access management unit 207 sets the file name aa, the step information of the application, the file path ax, and the measured time in the file name 2101, the step 2102, the file path A (2104), and the measured value A (2105), respectively. At this time, since there is no record of previous access, which is a target for comparison with the measured time, the access management unit 207 sets “0” in the delay flag 2103.

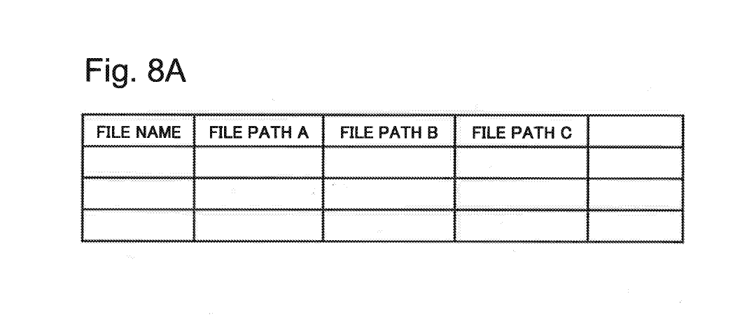

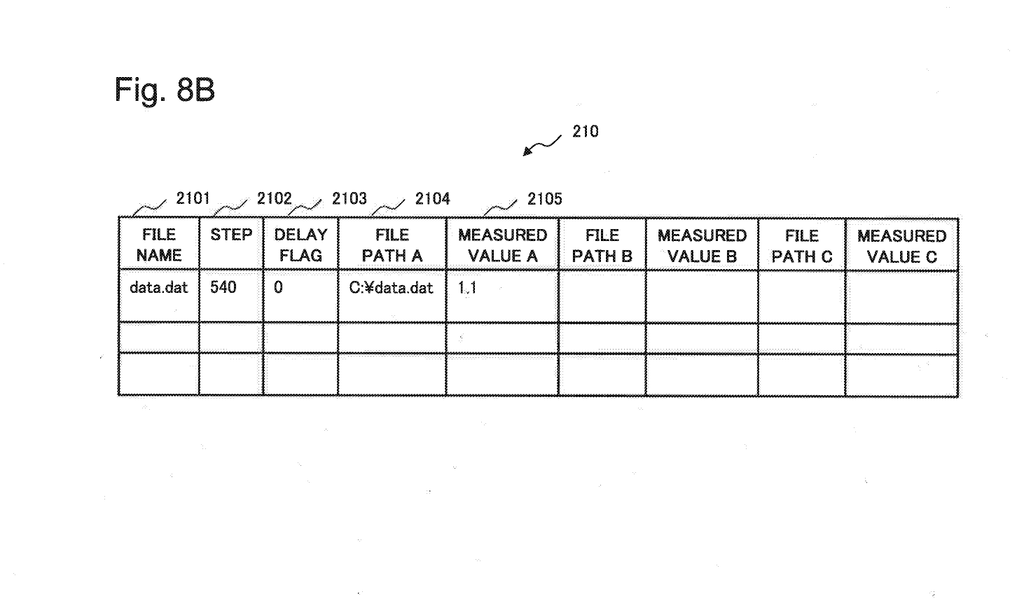

These processes result in the path conversion table 208 and the access record table 210 having contents illustrated in FIGS. 8A and 8B. FIG. 8A is a diagram exemplifying a path conversion table obtained after a first file access according to the second example embodiment of the present invention. FIG. 8B is a diagram exemplifying an access record table obtained in the time.

Then, the access management unit 207 transfers the data 320 to the server application execution unit 203.

Next, a case of access to the same file (file ad) for the second time will be described.

The access management unit 207 checks a value of the delay flag 2103 since an access target file is registered in the access record table 210 (“YES” at Step S610) (Step S620).

Since the delay flag 2103 relating to the file ad is “0” in the access record table 210 in FIG. 8B, the path conversion unit 206 refers to the path conversion table 208. The path conversion unit 206 transfers a content of the file path ax as it is to the access unit 205 since a file path of destination converted from the file path ax is not registered (no value is set in the file path B (2083) relating to the file ad).

The access unit 205 measures time required for reading data through Steps S670 to S690 described above.

The access unit 205 transfers the read data 320 and the measured time to the path conversion unit 206. The path conversion unit 206 transfers information transferred from the access unit 205 and information representing a file path (file path ax) to the access management unit 207.

The access management unit 207 checks, by referring to the access record table 210, that there is information on previous access to the file ad (“YES” at Step S700).

The access management unit 207 compares the measured time with previous reading time (measured value A (2105)) present in the access record table 210 (Steps S710 and S730).

When a difference in reading time is equal to or greater than a predetermined threshold value, that is, when reading time is prolonged by the threshold value or more in comparison with previous reading time (“YES” at Step S710), the access management unit 207 determines that performance is degraded. Thus, the access management unit 207 sets the delay flag 2103 relating to the file ad in the access record table 210 to “1” (Step S720).

The access management unit 207 further updates other items of the access record table 210 by using information transferred from the path conversion unit 206 (Step S750). In other words, the access management unit 207 sets the measured time in the measured value A (2105) relating to the file name aa.

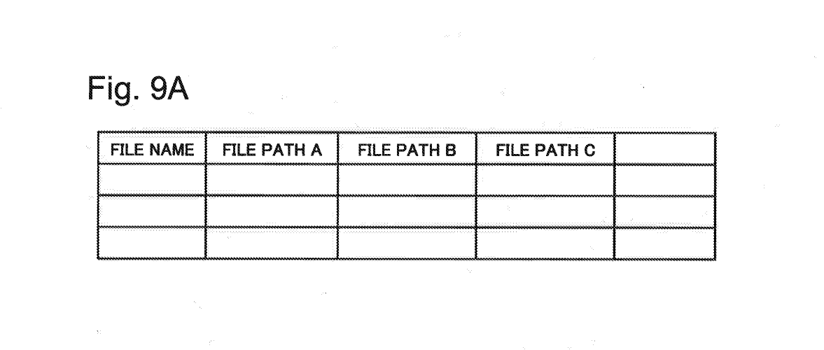

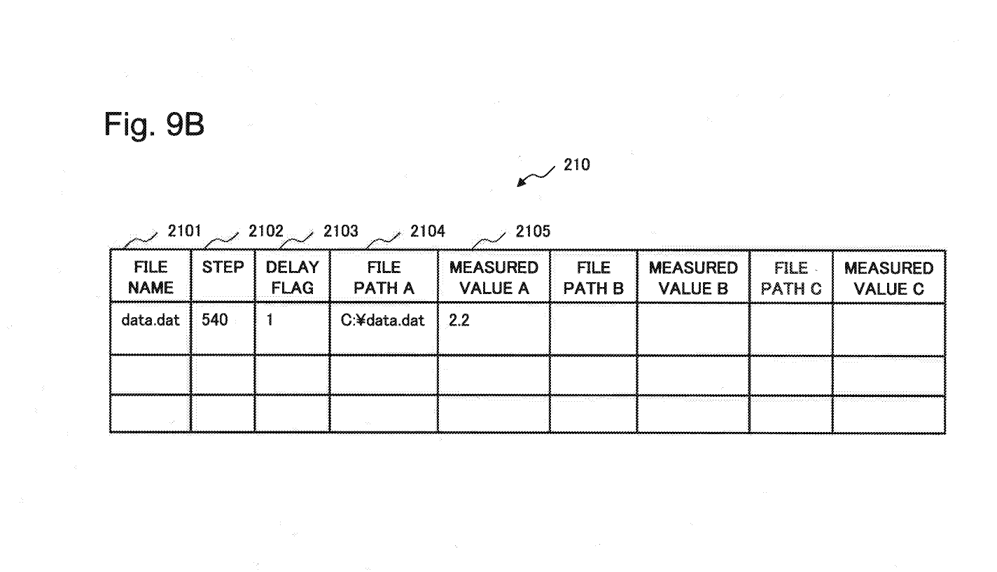

These processes result in the path conversion table 208 and the access record table 210 having contents illustrated in FIGS. 9A and 9B. FIG. 9A is a diagram exemplifying a path conversion table obtained after detection of prolonged file access time according to the second example embodiment of the present invention. FIG. 9B is a diagram exemplifying an access record table obtained in the time.

Next, a case of access to the same file for the third time will be described.

Since an access target file is registered in the access record table 210 (“YES” at Step S610), the access management unit 207 checks a value of the delay flag 2103 (Step S620).

Since the delay flag 2103 relating to the file ad is “1” in the access record table 210 in FIG. 9B, the access management unit 207 adds a file (Step S630).

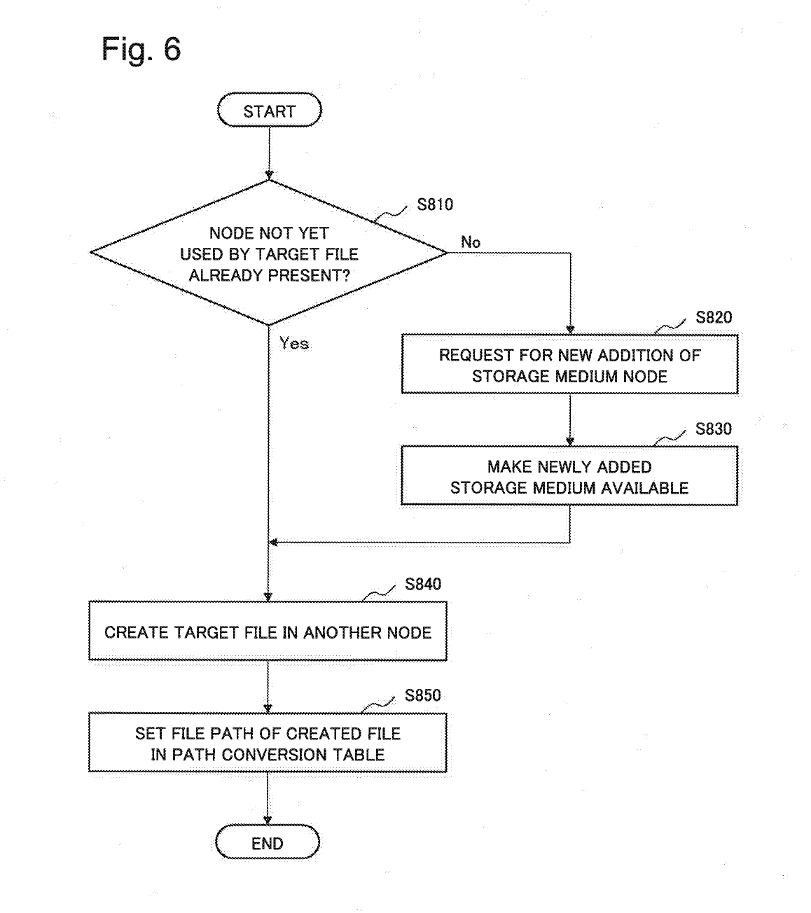

A process for adding a file at Step S630 will be described with reference to FIG. 6. FIG. 6 is a flowchart illustrating a process for adding a file according to the second example embodiment of the present invention.

The access management unit 207 checks whether there is already a storage medium node which has not yet been used by a target file (Step S810).

When there is no storage medium node which has not yet been used (“No” at Step S810), the access management unit 207 requests the node change instruction unit 204 to newly add a storage medium node (Step S820).

The node change instruction unit 204 sends a request for new addition of a storage medium node to the cloud node management device 002 via the communication unit 201 and the communication unit 003.

The cloud node management device 002 newly sets the storage medium node 301 indicated by a dashed line in FIG. 2. The cloud node management device 002 then newly creates a storage medium 311 included in the storage medium node 301 and assigns the storage medium 311 as a disk physically different from the storage medium 310. Then, the cloud node management device 002 returns, to the node change instruction unit 204, access means to the storage medium 311 described later.

Upon receiving the access means to the storage medium 311, the node change instruction unit 204 executes the access means so as to make the storage medium 311 available (Step S830). The access means is, for example, information capable of identifying a virtual machine, such as Internet Protocol (IP) address and a host name of a virtual machine. The node change instruction unit 204 uses the information so as to make the storage medium 311 available by, for example, mounting the same.

The access management unit 207 instructs the path conversion unit 206 to create (copy) the file ad in the storage medium 311. Upon receiving the instruction, the path conversion unit 206 transfers a file path (file path ax) for access to the file ad in use and instructs the access unit 205 to create a file in the storage medium 311.

The access unit 205 having accepted the instruction creates the file ad in the storage medium 311 (Step S840). At this time, the measurement unit 209 does not measure time. It is assumed that a file path of the created file is “D:¥Data.dat” (hereinafter, referred to as a “file path bx”).

The access management unit 207 writes file path information relating to the created file (=file ad) in the path conversion table 208 (Step S850). In other words, the access management unit 207 sets the file name aa, the file path ax, and the file path bx in the file name 2081, the file path A (2082), and the file path B (2083), respectively.

The description about the operation of file addition with use of FIG. 6 is completed.

Returning again to FIG. 5, the access management unit 207 changes the delay flag 2103 in the access record table 210 to “0” (Step S650).

The path conversion unit 206 checks with the path conversion table 208 and transfers the file path bx, which is a path at a destination for conversion, as a file path associated with the file ad to the access unit 205.

The access unit 205 measures time required for reading data in the same manner as in the above description (Steps S670 to S690). The access unit 205 herein reads data by using the file path bx transferred from the path conversion unit 206. In other words, the access unit 205 reads data stored in the storage medium 311.

The access unit 205 transfers the read data 320 and the measured time to the path conversion unit 206. The path conversion unit 206 transfers information transferred from the access unit 205 and information representing a file path (file path bx) to the access management unit 207.

The access management unit 207 compares the measured time with previous reading time (measured value A (2105)) present in the access record table 210 (Steps S710 and S730).

When a difference in reading time is equal to or greater than a predetermined threshold value, that is, when the reading time is shortened by the threshold value or more in comparison with previous reading time (“YES” at Step S730), the access management unit 207 determines that performance is recovered. Thus, the access management unit 207 sets the delay flag 2103 in the access record table 210 to “−1” (Step S740).

The access management unit 207 further updates other items of the access record table 210 by using information transferred from the path conversion unit 206 (Step S750). In other words, the access management unit 207 sets the file path bx in the file path B (2106) relating to the file name aa and the measured time in the measured value B (2107).

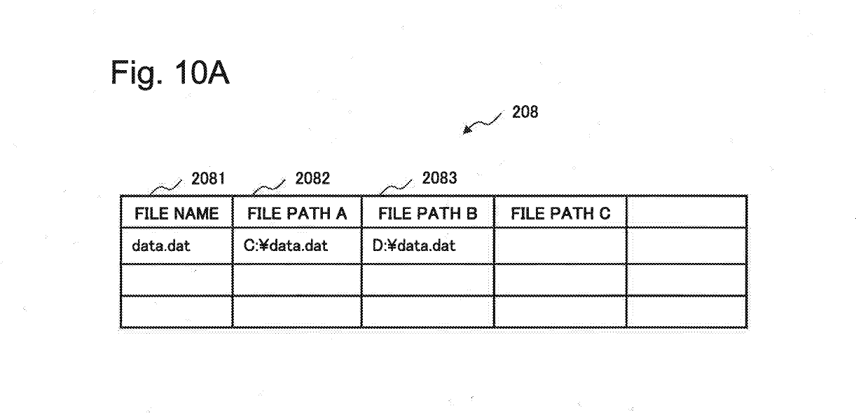

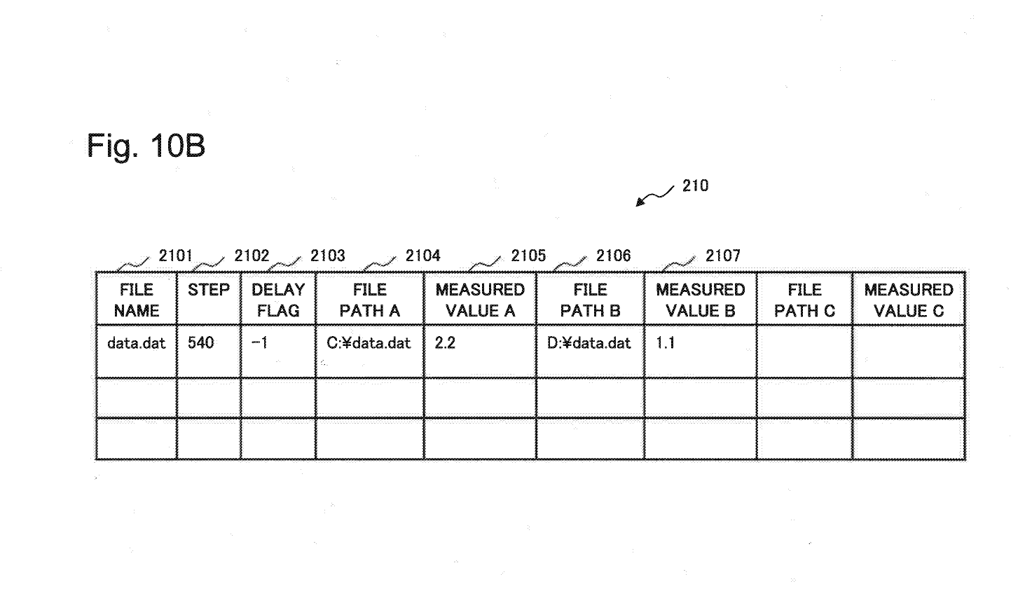

These processes result in the path conversion table 208 and the access record table 210 having contents illustrated in FIGS. 10A and 10B. FIG. 10A is a diagram exemplifying a path conversion table obtained after detection of shortened file access time according to the second example embodiment of the present invention. FIG. 10B is a diagram exemplifying an access record table obtained in the time.

Next, a case of access to the same file for the fourth time will be described.

Since an access target file is registered in the access record table 210 (“YES” at Step S610) the access management unit 207 checks a value of the delay flag 2103 (Step S620).

Since the delay flag 2103 relating to the file ad is “−1” in the access record table 210 in FIG. 10B, the access management unit 207 determines that a newest file is unnecessary. Then the access management unit 207 performs a process for deleting the file (Step S640).

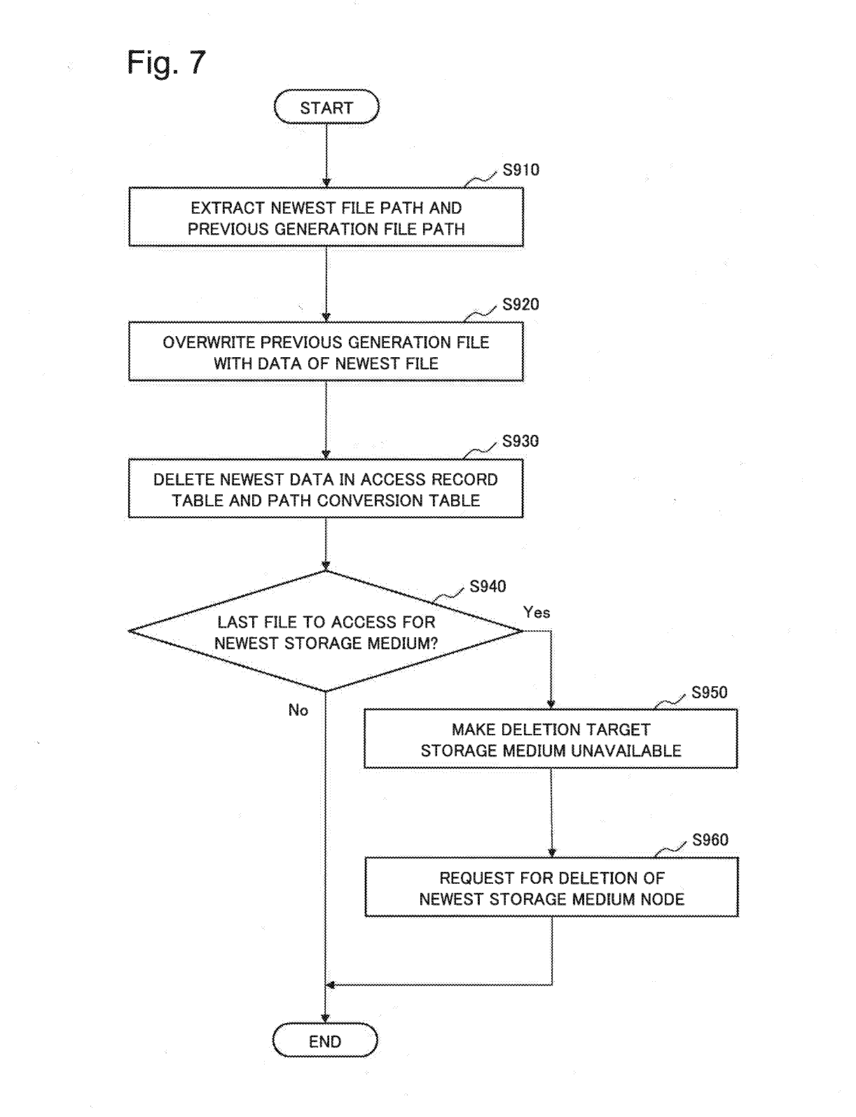

The process for deleting the file at Step S640 will be described with reference to FIG. 7. FIG. 7 is a flowchart illustrating the process for deleting the file according to the second example embodiment of the present invention.

The access management unit 207 refers to the path conversion table 208 and extracts a newest file path and a previous generation file path from file paths of a target file (Step S910). In FIGS. 10A and 10B, the newest file path and the previous generation file path are “D:¥data.dat” and “C:¥data.dat”, respectively.

The access management unit 207 instructs the path conversion unit 206 to overwrite the previous generation file with contents included in newest file for the target file. In response to this instruction, the path conversion unit 206 transfers a file path (file path bx) for access to the file ad in use and instructs the access unit 205 for overwriting.

The access unit 205 having received the instruction overwrites a previous generation storage medium (herein, the storage medium 310) with the target file stored in a newest storage medium (herein, the storage medium 311) (Step S920). At this time, the measurement unit 209 does not measure time.

Next, the access management unit 207 deletes a record relating to the file path bx which is information on the newest file in the path conversion table 208 and the access record table 210 (Step S930).

Then, the access management unit 207 confirms that there is no other application using the storage medium node 301 and the storage medium 311 (Step S940).

When there is no other application using the storage medium node 301 and the storage medium 311 (“YES” at Step S940), the access management unit 207 requests the node change instruction unit 204 to delete a storage medium node.

The node change instruction unit 204 invalidates the access means of the storage medium 311 (Step S950). For example, the node change instruction unit 204 unmounts the storage medium 311.

Thereafter, the node change instruction unit 204 sends a request for deletion of the storage medium node to the cloud node management device 002 via the communication unit 201 and the communication unit 003 (Step S960). The cloud node management device 002 deletes the storage medium node 301 and the storage medium 311.

The description about the operation of file deletion with use of FIG. 7 is completed.

Returning again to FIG. 5, the access management unit 207 changes the delay flag 2103 in the access record table 210 to “0” (Step S650).

The access management unit 207 checks with the path conversion table 208 by means of the path conversion unit 206 to confirm that there is no other path converted from the file path ax, and transfers the file path ax to the access unit 205.

The access unit 205 measures time required for reading data in the same manner as in the above description (Steps S670 to S690). The access unit 205 herein reads data by using the file path ax transferred from the path conversion unit 206. In other words, the access unit 205 reads data stored in the storage medium 310.

The access unit 205 transfers the read data 320 and the measured time to the path conversion unit 206. The path conversion unit 206 transfers information transferred from the access unit 205 and information representing a file path (file path ax) to the access management unit 207.

The access management unit 207 compares the measured time with previous reading time (measured value A (2105)) present in the access record table 210 (Steps S710 and S730).

When a difference in reading time is a value within a normal range (reading time is neither shortened nor prolonged by a predetermined threshold value or more) (“No” at Step S730), the access management unit 207 does not update the delay flag 2103 in the access record table 210 (keeps “0”).

The access management unit 207 further updates other items of the access record table 210 by using information transferred from the path conversion unit 206 (Step S750). In other words, the access management unit 207 sets the measured time in the measured value A (2105) relating to the file name aa.

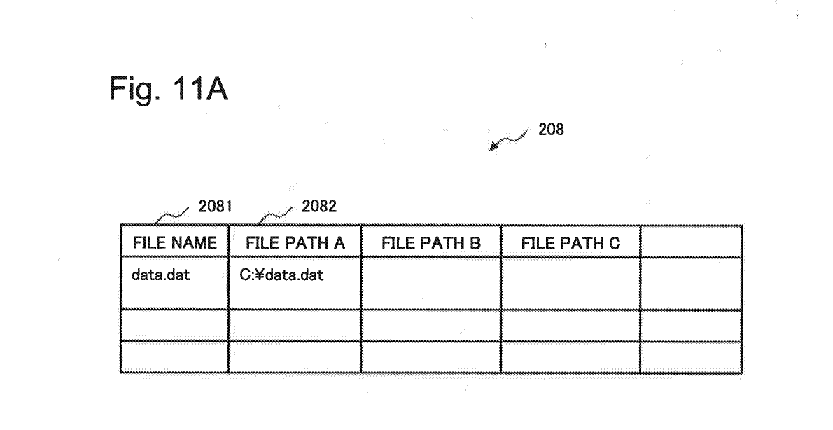

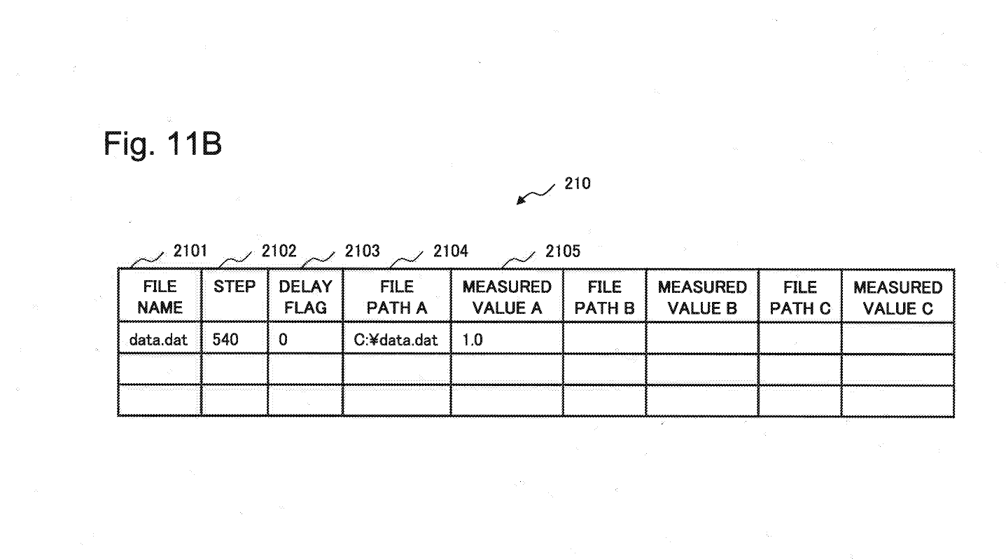

These processes result in the path conversion table 208 and the access record table 210 having contents illustrated in FIGS. 11A and 11B. FIG. 11A is a diagram exemplifying a path conversion table obtained when file access time is neither prolonged nor shortened according to the second example embodiment of the present invention. FIG. 11B is a diagram exemplifying an access record table obtained in the time.

In the above example embodiment, description has been given of a case in which an application accesses a file. However, the above example embodiment can be carried out similarly in a case in which an application accesses a database. In the above description, the measurement unit 209 measures time taken for access to a file. However, in a case of a database, the measurement unit 209 measures time taken for query execution. The application server node 200 determines prolongation of database access based on the measured time. When detecting prolongation, the application server node 200 may perform control so as to move the database used in the query processing to another storage medium by export and import.

Description has been given of an example in which delay in access to a storage medium (a file or a database) is determined by using time taken for the access. However, an item to be used in the determination is not limited thereto. For example, the measurement unit 209 may measure a data transmission amount per unit time during access. The access management unit 207 may estimate, based on a value of the data transmission amount, a load to a storage medium.

A data transmission efficiency of a storage medium is determined mainly by hardware performance and an access load of the storage medium and a network load. When assuming that hardware performance and a network load are constant, it is considered that a data transmission efficiency fluctuates due to an influence of an access load of a plurality of processes to a storage medium. In view of this, when accessing a file by an application, the measurement unit 209 measures a data transmission efficiency. The access management unit 207 compares a data transmission amount per unit time with previous access. When the data transmission amount is lowered by a predetermined threshold value or more as a result of the comparison, the access management unit 207 determines that a load on a storage medium node is high due to concentration of other processes. The access management unit 207 performs control, by adding another storage medium node, to switch a storage medium to be accessed. This makes it possible to avoid delay in all processes due to delay in a file access process.

As has been described above, the second example embodiment eliminates delay in access to a storage medium occurring in an application program running on an application server in a cloud environment in the same manner as in the first example embodiment. The second example embodiment further has an advantageous effect of being capable of performing control so as not to use a storage medium too much by reducing an added storage medium when there is a margin of performance in access to a storage medium.

The reason is that the application server according to the present example embodiment monitors performance by measuring time taken for access to a file and comparing a value of the time with time for previous access. When detecting occurrence of delay, the application server performs control so as to newly create the file in another medium and run an application using the created file. In addition, when detecting that there is a margin of performance, the application server performs control so as to delete an added file and run an application using an original file.

### Third Example Embodiment

Next, a third example embodiment using the application server according to the above-described second example embodiment as a basis will be described. It is assumed that a configuration of an information processing system according to the third example embodiment is the same as that according to the second example embodiment illustrated in FIG. 2. However, the difference is as follows.

In the second example embodiment, whether a load on a storage medium storing a file is high or not is determined by comparing time required for previous access to the file with time required for current access.

However, in the method, since no absolute criterion of file access time is set for each file access process, there is a possibility of erroneously determining whether performance is delayed or not. For example, when access time is shorter than previous time even though processing is prolonged compared with normal time, the access management unit 207 determines that there is no delay in file access.

In view of the above, in the present example embodiment, time required for a file access process is recorded and accumulated for a plurality of times of file access as an access record table. The access management unit 207 calculates, based on the time required for file access of the plurality of times, a statistical value such as an average value and a standard deviation for each file access process, and stores the value in the access record table. The access management unit 207 uses the statistical value for the purpose of determining whether a load on a storage medium is high due to access to each file or not. Accordingly, the access management unit 207 is able to determine presence and absence of performance degradation effectively even when performance degradation in a storage medium temporarily continues.

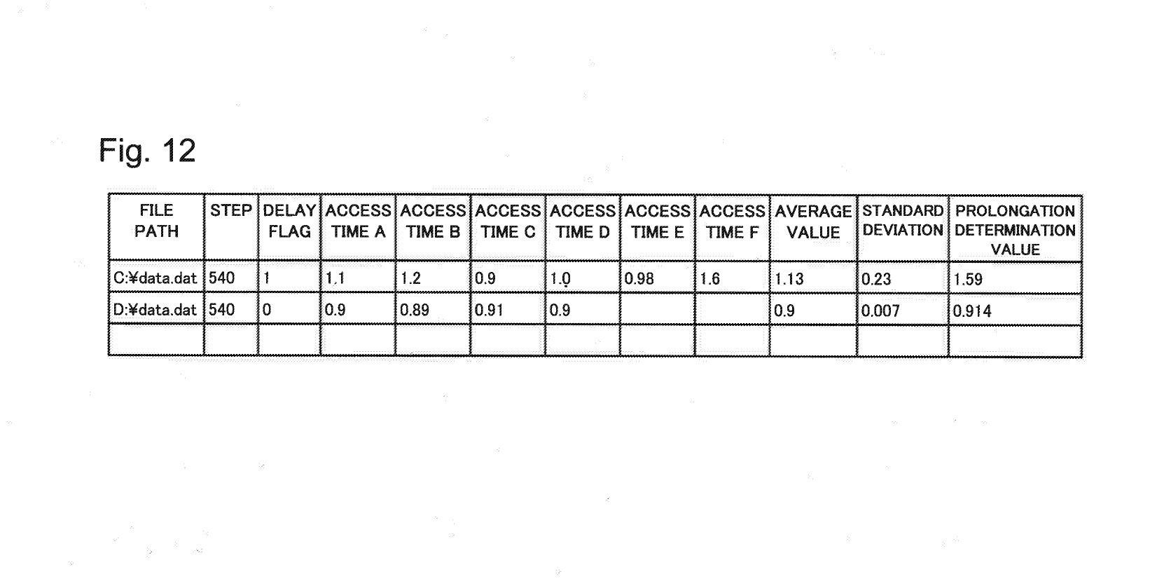

An example of a case is illustrated in FIG. 12 in which file access times for a plurality of times of file access are recorded and accumulated for calculation. FIG. 12 is a diagram exemplifying an access record table according to the third example embodiment of the present invention. According to FIG. 12, based on access times for a plurality of times, an average value and a standard deviation are calculated. For example, when a file access time takes a value equal to or more than a time of “average value+standard deviation×2” (in a case of normal distribution, a value which can be taken at 2.275%) as a threshold value (prolongation determination value), the access management unit 207 determines that performance is degraded.

As has been described above, the third example embodiment has an advantageous effect of being capable of effectively determining presence and absence of performance degradation even when performance degradation in a storage medium temporarily continues and improving the performance degradation.

The reason is that the application server according to the present example embodiment records a file access time for each access to a file, and determines performance degradation from a statistical value obtained based on a plurality of file access times.

### Fourth Example Embodiment

Next, a fourth example embodiment using the application server according to the above-described second example embodiment as a basis will be described.

The present example embodiment assumes that performance degradation in file access is determined for a file accessed from a plurality of application server nodes.

In the second example embodiment, the application server node 200 manages arrangement of a file to be accessed at the application server node 200. In other words, the application server node 200 includes the path conversion table 208 and the access record table 210.

However, in the present example embodiment, the path conversion table 208 and the access record table 210 are necessary to be included at a location which can be referenced by a plurality of application server nodes and software accessing a file.

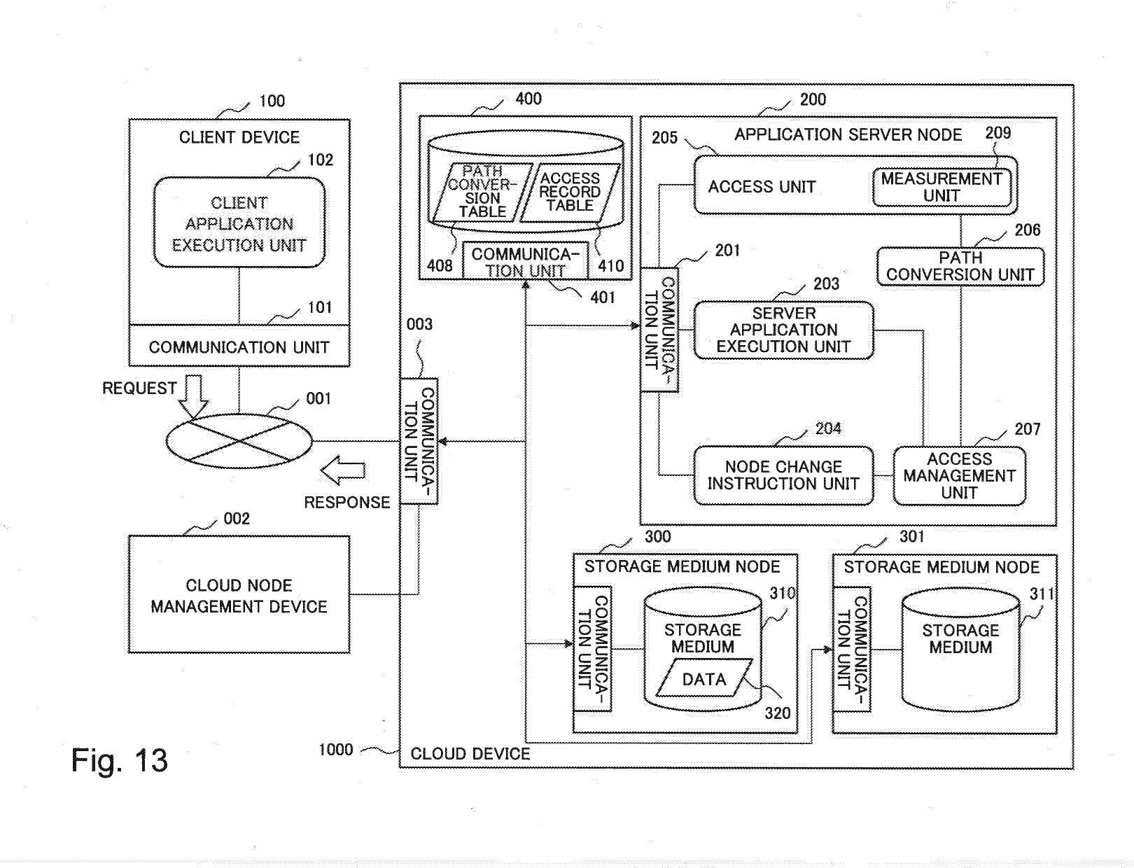

FIG. 13 is a block diagram illustrating a configuration of a system according to the fourth example embodiment of the present invention.

In FIG. 13, a node 400 is included additionally to FIG. 2.

The node 400 includes a communication unit 401, a path conversion table 408, and an access record table 410.

The communication unit 401 performs communication between the node 400 and another node.

The path conversion table 408 is the same as the path conversion table 208 in the second example embodiment, and thus, description therefor is omitted.

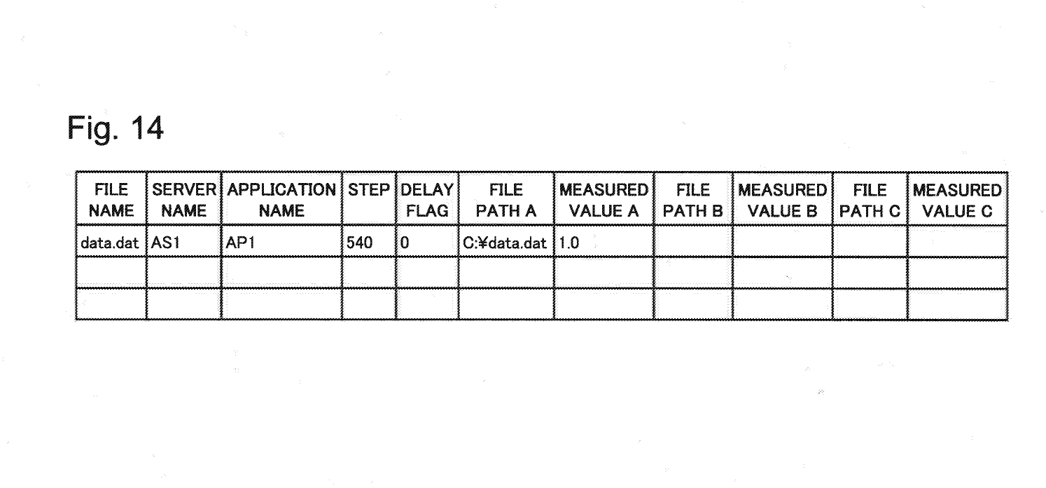

The access record table 410 includes a server name and an application name additionally to the access record table 210 in the second example embodiment. FIG. 14 is a diagram exemplifying an access record table according to the fourth example embodiment of the present invention.

The server name is a name of a server on which an application accessing a file runs.

The application name is an identification name uniquely representing an application accessing a file.

A flow of processing in the present example embodiment is the same as that in the second example embodiment, and thus, description therefor is omitted.

As has been described above, the fourth example embodiment has an advantageous effect of being capable of eliminating delay occurring in access to a storage medium accessed from a plurality of application server nodes and software.

The reason is that the cloud device according to the present example embodiment stores information relating to access to a storage medium in a location which can be referenced from a plurality of application server nodes and software being capable of accessing a file of the storage medium. The cloud device determines occurrence of delay in access based on the information.

### (Hardware Configuration)

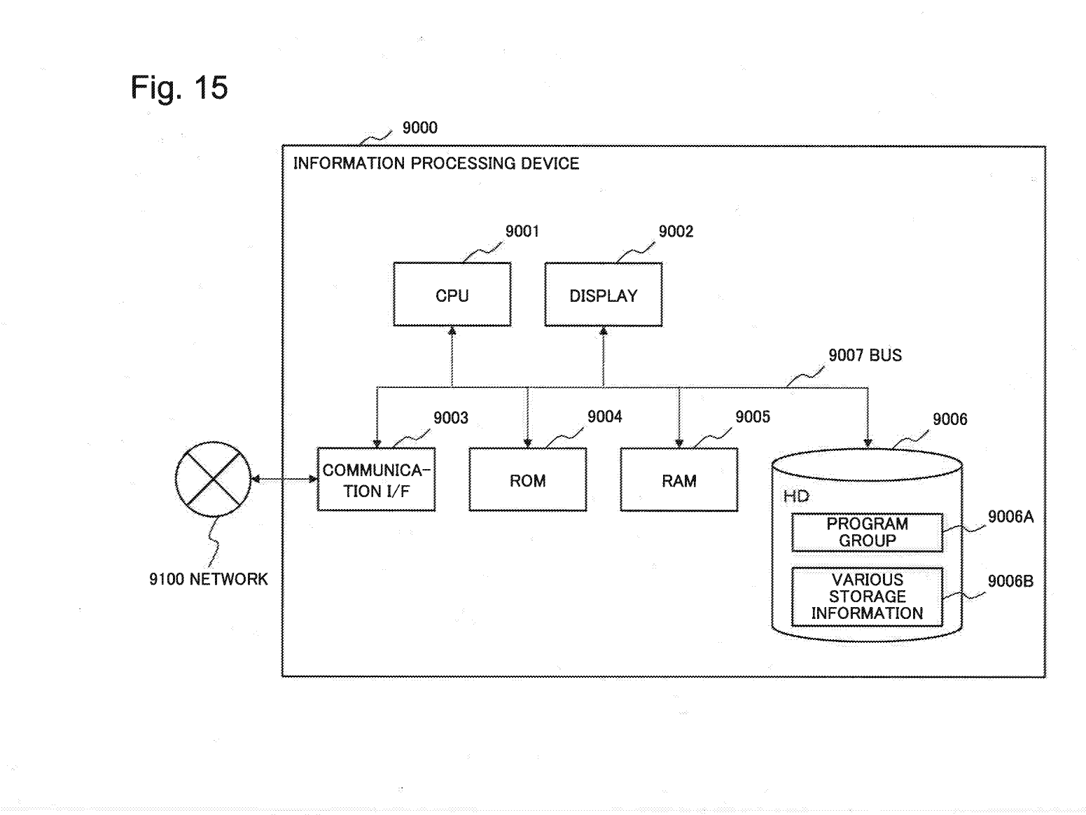

In the example embodiments described above, each of the units illustrated in FIGS. 1, 2, and 13 may be practiced by a dedicated device, but can be regarded as a functional (process) unit of a software program (software module). However, in implementation of each of the units illustrated in the drawings, various configurations can be assumed. An example of a hardware environment in such a case will be described with reference to FIG. 15.

FIG. 15 is a diagram illustratively describing a hardware configuration of a computer (information processing device) capable of implementing the first to fourth example embodiments of the present invention. In other words, FIG. 15 represents a hardware environment which is a configuration of a computer (information processing device) capable of implementing all or part of an application server described below and which is capable of implementing each of the functions in the above-described example embodiments. The application server is the application server 20 illustrated in FIG. 1. In addition, the application server is the application server running on the application server node 200 illustrated in FIG. 2. Alternatively, the application server is the application server running on the application server node 200 illustrated in FIG. 13.

The information processing device 9000 illustrated in FIG. 15 is configured to include the following devices connected via a bus 9007.
a CPU (Central Processing Unit) 9001;
a display 9002;
a communication interface (I/F) 9003;
a Read Only Memory (ROM) 9004;
a Random Access Memory (RAM) 9005; and
a hard disk device (HD) 9006.

In the hard disk device (HD) 9006, a program group 9006A and various storage information 9006B are stored. The program group 9006A is a computer program for implementing a function corresponding to each of blocks (units) described below. Each of the blocks belongs to, for example, the application server 20 illustrated in FIG. 1 described above, the application server running on the application server node 200 illustrated in FIG. 2, or the application server node 200 illustrated in FIG. 13. The various storage information 9006B is, for example, the path conversion table 208 and the access record table 210 illustrated in FIG. 2 and the path conversion table 408 and the access record table 410 illustrated in FIG. 13. The communication interface 9003 is general communication means for implementing communication with an external device via a network 9100.

The present invention having been described using each of the above example embodiments as an example supplies a computer program capable of implementing the functions in the block configuration diagram or a flowchart referred in the description of each of the example embodiments. The present invention is accomplished by reading the computer program into the CPU 9001 as hardware and executing the computer program by use of a hardware resource in the information processing device 9000 illustrated in FIG. 15. Specifically, when implementing the application server running on the application server node 200 by using the information processing device 9000, the information processing device 9000 may implement a computer program corresponding to each of the flowcharts illustrated in FIGS. 5 to 7. In addition, the computer program supplied into the information processing device 9000 may be stored in a non-volatile storage device (storage medium) such as the readable/writeable RAM 9005 or the hard disk device 9006.

In the case, a general procedure can be employed nowadays as a method of supplying a computer program into the device. Examples of the method of supplying a computer program include a method of installing the same in the device via a variety of storage media such as a CD-ROM and a method of downloading the same externally via the network 9100 such as the Internet. In such a case, the present invention can be regarded as being configured by a code configuring the computer program or a computer-readable storage medium in which the code is recorded.

The present invention has been described using each of the example embodiments described above as an exemplary example. However, the present invention is not limited to the above-described example embodiments. In other words, various modes that a person skilled in the art can understand can be applied to the present invention within the scope of the present invention.

This application is based upon and claims the benefit of priority from Japanese Patent Application No. 2014-193422, filed on Sep. 24, 2014, the disclosure of which is incorporated herein in its entirety.

### REFERENCE SIGNS LIST

10 Client device
20 Application server
21 Execution unit
22 Measurement unit
23 Management unit
30 Storage medium
001 Network
002 Cloud node management device
003 Communication unit
100 Client device
101 Communication unit
102 Client application execution unit
200 Application server node
201 Communication unit
203 Server application execution unit
204 Node change instruction unit
205 Access unit
206 Path conversion unit
207 Access management unit
208 Path conversion table
209 Measurement unit
210 Access record table
300, 301 Storage medium node
310, 311 Storage medium
320 Data
400 Node
401 Communication unit
408 Path conversion table
410 Access record table
1000 Cloud device
9000 Information processing device (computer)
9001 CPU
9002 Display
9003 Communication interface (I/F)
9004 ROM
9005 RAM
9006 Hard disk device (HD)
9006A Program group
9006B Various storage information
9007 Bus
9100 Network

What is claimed is:

1. An application server comprising:
a execution unit which executes an application program in response to a request from a client device and returns a response to the client device;
a measurement unit which measures a value representing performance in access to a storage medium through execution of the application program; and
a management unit which, when determining that the performance relating to access to the storage medium is degraded based on the value measured by the measurement unit, performs control so as to add another storage medium.

2. The application server according to claim 1, wherein
the management unit, when determining that the performance is recovered based on the value measured by the measurement unit, further performs control so as to delete the added storage medium.

3. The application server according to claim 1, wherein
the measurement unit measures time taken for access to the storage medium.

4. The application server according to claim 1, wherein
the measurement unit measures a data transmission amount per unit time during access to the storage medium.

5. The application server according to claim 1, wherein
the execution unit includes:
a server application execution unit which executes the application program;
a access unit which performs the access to the storage medium due to an instruction from the application program;
a access record unit which records a history of the value representing the performance in the access measured by the measurement unit;
a path conversion record unit which records a path for use in the access; and
a path conversion unit which refers to the path conversion record unit and obtains the path for use, and
the management unit includes:
a access management unit which determines degradation of the performance relating to the access to the storage medium by comparing the value representing the performance in the access measured by the measurement unit with the history of the value representing the performance recorded in the access record unit; and
a node change instruction unit which, when determining that the performance is degraded, instructs to add the other storage medium.

6. (canceled)

7. A storage medium access monitoring method comprising:
executing an application program in response to a request from a client device;
measuring a value representing performance in access to a storage medium through execution of the application program; and
performing, when determining that the performance relating to the access to the storage medium is degraded based on the measured value, control so as to add another storage medium.

8. A computer-readable storage medium storing a computer program which causes a computer to execute:
execution processing of executing an application program in response to a request from a client device and returning a response to the client;
measurement processing of measuring a value representing performance in access to a storage medium through execution of the application program; and
management processing of, when determining that the performance relating to the access to the storage medium is degraded based on the value measured by the measurement processing, performing control so as to add another storage medium.
